(19) United States
(12) Patent Application Publication
(10) Pub. No.: US 2025/0157011 A1
(43) Pub. Date: May 15, 2025

(54) SYSTEM AND METHOD FOR ENHANCING THE QUALITY OF A VIDEO

(71) Applicant: SAMSUNG ELECTRONICS CO., LTD., Suwon-si (KR)

(72) Inventor: Anurag Mithalal JAIN, Bangalore (IN)

(73) Assignee: SAMSUNG ELECTRONICS CO., LTD., Suwon-si (KR)

(21) Appl. No.: 19/028,171

(22) Filed: Jan. 17, 2025

(30) Foreign Application Priority Data
Aug. 11, 2022 (IN) 202241027221
Jun. 23, 2023 (IN) 202241027221

(51) Int. Cl. G06T 5/70; G06T 3/18; G06T 5/90; G06T 7/11; G06T 7/20; G06V 10/24; G06V 10/762

(52) U.S. Cl. CPC G06T 5/70; G06T 3/18; G06T 5/90; G06T 7/11; G06T 7/20; G06V 10/24; G06V 10/762

(57) ABSTRACT

A method for capturing a video with enhanced quality includes: capturing a reference image via a user equipment (UE), where the reference image is at least one frame of a plurality of frames of the video or an image associated with the video; segmenting the captured reference image into one or more regions; receiving one or more first enhancement parameters for a first region of the one or more regions; initiating a capture of the video based on the one or more first enhancement parameters; identifying a plurality of pixels associated with the first region in each of the plurality of frames of the captured video; and applying the one or more first enhancement parameters to the identified plurality of pixels associated with the first region in each of the plurality of frames.

### CROSS-REFERENCE TO RELATED APPLICATION(S)

This application is a continuation of International Application No. PCT/KR2023/011968, filed on Aug. 11, 2023, in the Korean Intellectual Property Receiving Office, which is based on and claims priority to Indian patent application Ser. No. 20/224,1027221, filed on Jun. 23, 2023, and Indian Provisional Patent Application No. 20/224,1027221, filed on Aug. 11, 2022, in the Indian Patent Office, the disclosures of which are incorporated by reference herein in their entireties.

### BACKGROUND

### 1. Field

The disclosure generally relates to image processing, for example, a system and a method for enhancing the quality of a video.

2. Description of Related Art

In the current era of high-speed data, the video industry is gaining popularity not only in the advertising and marketing sectors, but also among the masses accessing social media. Therefore, there is an urgent need to focus on generation of high-resolution videos.

Currently, the users are provided with a few options under the camera settings of electronic devices (e.g., smartphones) to assist the users decide which settings are the best for video recordings. However, even under identical conditions, there is still a significant difference in quality between still images and video recording even though resolutions are comparable. Although, the users have some level of control (e.g., frames per second (fps), exposure, resolution, etc.) to improve the image quality, these control remains insufficient, and the difference in the quality observed between the still images and the recorded videos is quite large. Further, a majority of processes linked with the still images do not apply to video recordings. Specifically, due to relaxed latencies, the still images may use sensors with longer exposure times. However, the exposure times for the video recordings are restricted to a maximum of 33 milliseconds (e.g., 30 fps). Further, due to a lack of need for a real-time output, the still images may afford additional processing time. Another reason for the difference between the quality of still images and the recorded videos is due to the production of still images with a high dynamic range based on a combination of multiple shots at various exposure levels. In the case of video recording, this is not feasible, since adjustments to the sensors' exposure may halt video streaming.

To enhance the quality of the video recording, certain existing methods include, for example, a pro-mode for video recording. The pro-mode offers one or more setting options, such as controlling international organization of standards (ISO) i.e., level of sensor gain, shutter speed, exposure value, focus value, white balance, zoom value, and the like. When a user of the electronic device selects one or more settings options, the settings are universally applied to the whole image or video. The user cannot apply distinct settings to each pixel or even a cluster of pixels due to hardware sensor read-out limits.

Thus, it is desired to address the above-mentioned disadvantages or shortcomings or at least provide a useful alternative for enhancing the quality of the video recording.

The above information is presented as background information only to assist with an understanding of the disclosure. No determination has been made, and no assertion is made, as to whether any of the above might be applicable as prior art with regard to the disclosure.

### SUMMARY

Aspects will be set forth in part in the description which follows and, in part, will be apparent from the description, or may be learned by practice of the presented embodiments.

According to an aspect of the disclosure, provided is a method for capturing a video with enhanced quality, the method may include: capturing a reference image via a user equipment (UE), where the reference image is at least one frame of a plurality of frames of the video or an image associated with the video; segmenting the captured reference image into one or more regions; receiving one or more first enhancement parameters for a first region of the one or more regions; initiating a capture of the video based on the one or more first enhancement parameters; identifying a plurality of pixels associated with the first region in each of the plurality of frames of the captured video; and applying the one or more first enhancement parameters to the identified plurality of pixels associated with the first region in each of the plurality of frames.

The method may further include: receiving one or more second enhancement parameters for a second region of the one or more regions; initiating the capture of the video based on the one or more second enhancement parameters; identifying a plurality of pixels associated with the second region in each of the plurality of frames of the captured video; and applying the one or more second enhancement parameters to the identified plurality of pixels associated with the second region in each of the plurality of frames.

A field of view (FOV) of the reference image may include the one or more regions included in the video.

The one or more first enhancement parameters may include at least one of: an exposure synthesis for enhancing a dynamic range of the captured video based on the one or more regions from the plurality of frames, one or more motion blur parameters for synthesizing a silhouette of long exposure effect, or noise reduction parameters in one or more relatively static regions of the captured video based on one or more frames from the plurality of frames.

The segmenting the reference image into the one or more regions may include: segmenting the reference image into one or more regions according to one or more region masks.

The identifying the plurality of pixels associated with the first region may include: tracking the one or more regions in the plurality of frames based on the one or more region masks and one or more classes; warping the tracked one or more regions; aligning the warped one or more regions; and identifying a plurality of pixels associated with each of the aligned one or more regions.

The applying the one or more first enhancement parameters to the identified plurality of pixels associated to the first region may include: applying one or more enhancement parameters to the identified plurality of pixels associated with the aligned one or more regions in each of the plurality of frames, where the one or more enhancement parameters include the one or more first enhancement parameters and one or more second enhancement parameters.

The method may further include: receiving motion information and one or more region masks; identifying a plurality of overlapping pixels from the one or more regions based on the received motion information and the one or more region masks; determining a temporal loss and a perceptual loss of the identified plurality of overlapped regions; determining a set of blend weights to minimize a total loss based on the determined temporal loss and the determined perceptual loss, wherein the total loss includes the temporal loss and the perceptual loss; and feathering one or more region boundaries associated with the one or more regions by using the determined set of blend weights on discontinuities across the one or more regions.

According to an aspect of the disclosure, further provided is a method for capturing a video with enhanced quality, the method may include: segmenting a first frame of a plurality of frames of the video into one or more regions, while capturing the video; providing at least one user interface for a user selection of one or more enhancement parameters for a selected region of the one or more regions of the first frame; and applying the one or more enhancement parameters to the selected region of the one or more regions of the first frame and a plurality of subsequent frames of the video during the video capture.

The method may further include: identifying, upon applying the one or more enhancement parameters to the selected region of the one or more regions, one or more cluster masks positioned on a boundary of the one or more regions in the plurality of frames based on one or more motion vectors and one or more region masks for each of the plurality of frames, wherein the one or more motion vectors are associated with one or more previous frames of a current frame in a time sequence; identifying a plurality of overlapping pixels from the one or more regions based on the identified one or more cluster masks; determining a temporal loss and a perceptual loss for the identified plurality of overlapping pixels based on the identified one or more cluster masks; determining a set of blending weights for the identified plurality of overlapping pixels based on the determined temporal loss and the determined perceptual loss; and feathering the identified plurality of overlapping pixels based on the determined set of blending weights.

According to an aspect of the disclosure, further provided is a system for capturing a video with enhanced quality, the system may include: a memory; and one or more processors communicatively coupled to the memory, where the one or more processors are configured to: capture a reference image via a user equipment (UE), where the reference image is at least one frame of a plurality of frames of the video or an image associated with the video, segment the captured reference image into one or more regions, receive one or more first enhancement parameters for a first region of the one or more regions, initiate a capture of the video based on the one or more first enhancement parameters, identify a plurality of pixels associated with the first region in each of the plurality of frames of the captured video, and apply the one or more first enhancement parameters to the identified plurality of pixels associated with the first region in each of the plurality of frames.

The one or more processors may be further configured to: receive motion information and one or more region masks, identify a plurality of overlapping pixels from the one or more regions based on the received motion information and the one or more region masks, determine a temporal loss and a perceptual loss of the identified plurality of overlapped regions, determine a set of blend weights to minimize a total loss based on the determined temporal loss and the determined perceptual loss, where the total loss includes the temporal loss and the perceptual loss, and feather one or more region boundaries associated with the one or more regions by using the determined set of blend weights on discontinuities across the one or more regions.

According to an aspect of the disclosure, further provided is a system for capturing a video with enhanced quality, the system may include: a memory; and one or more processors communicatively coupled to the memory, wherein the one or more processors are configured to: segment a first frame of a plurality of frames of the video into one or more regions, while capturing the video, provide at least one user interface for a user selection of one or more enhancement parameters for a selected region of the one or more regions of the first frame, and apply the one or more enhancement parameters to the selected region of the one or more regions of the first frame and a plurality of subsequent frames of the video during the video capture.

The one or more processors may be further configured to: identify, upon applying the one or more enhancement parameters to the one or more regions, one or more cluster masks positioned on a boundary of the one or more regions in the plurality of frames based on one or more motion vectors and one or more region masks for each of the plurality of frames, where the one or more motion vectors are associated with one or more previous frames of a current frame in a time sequence, identify a plurality of overlapping pixels from the one or more regions based on the identified one or more cluster masks, determine a temporal loss and a perceptual loss for the identified plurality of overlapping pixels based on the identified one or more cluster masks, determine a set of blending weights for the identified plurality of overlapping pixels based on the determined temporal loss and the determined perceptual loss, and feather the identified plurality of overlapping pixels based on the determined set of blending weights.

To further clarify the advantages and features of the disclosure, a more particular description of the disclosure will be rendered by reference to specific embodiments thereof, which is illustrated in the appended drawings. It is appreciated that these drawings depict only typical embodiments of the disclosure and are therefore not to be considered limiting of its scope. The disclosure will be described and explained with additional specificity and detail with the accompanying drawings.

### BRIEF DESCRIPTION OF DRAWINGS

The above and other aspects, features, and advantages of certain embodiments of the present disclosure will be more apparent from the following description taken in conjunction with the accompanying drawings, in which:

FIG. 1 illustrates a block diagram of a User Equipment (UE) comprising a system for enhancing a quality of a video, according to an embodiment of the disclosure;

FIG. 2 illustrates a block diagram of a plurality of modules of the system for enhancing the quality of the video, according to an embodiment of the disclosure;

FIG. 3A and FIG. 3B illustrate a block diagram depicting an operation of the system for enhancing the quality of the video, according to an embodiment of the disclosure;

FIG. 4A illustrates a block diagram depicting an operation of the system for enhancing the quality of the video, according to an embodiment of the disclosure;

FIG. 4B illustrates a block diagram depicting an operation of the system for enhancing the quality of the video, according to an example embodiment of the disclosure;

FIG. 5 illustrates a block diagram depicting a temporal consistency operation, according to an embodiment of the disclosure;

FIG. 6 illustrates a block diagram depicting generation of aligned regions from the video at each time stamp, in accordance with an example embodiment of the disclosure;

FIG. 7 illustrates a block diagram depicting a region-specific video refinement in a long exposure motion blur scenario, in accordance with an example embodiment of the disclosure;

FIG. 8 is a flow diagram illustrating a method for enhancing a quality of a video, in accordance with an example embodiment of the disclosure;

FIG. 9 is a flow diagram illustrating a method for feathering one or more region boundaries, in accordance with an example embodiment of the disclosure;

FIG. 10 is a flow diagram illustrating a method for enhancing the quality of the video, in accordance with and example embodiment of the disclosure;

FIG. 11 is a flow diagram illustrating a method for feathering the one or more region boundaries, in accordance with an example embodiment of the disclosure; and

FIG. 12A and FIG. 12B illustrate a user interface screen for selecting a region and applying an enhancement parameter to the selected region according to an embodiment.

Further, skilled artisans will appreciate that elements in the drawings are illustrated for simplicity and may not have necessarily been drawn to scale. For example, the flow charts illustrate the method in terms of the most prominent steps involved to help to improve understanding of aspects of the disclosure. Furthermore, in terms of the construction of the device, one or more components of the device may have been represented in the drawings by conventional symbols, and the drawings may show only those specific details that are pertinent to understanding the embodiments of the disclosure so as not to obscure the drawings with details that will be readily apparent to those of ordinary skill in the art having the benefit of the description herein.

### DETAILED DESCRIPTION

In this disclosure, it should be understood that the term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include,” “comprise,” “have,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many, if not most instances, such definitions apply to prior as well as future uses of such defined words and phrases.

FIG. 1 illustrates a block diagram of a user equipment (UE) 100 comprising a system 102 for enhancing a quality of a video, according to an embodiment of the disclosure. In an embodiment of the disclosure, the system 102 may be hosted on the UE 100. In an exemplary embodiment of the disclosure, the UE 100 may correspond to a smartphone, a laptop computer, a desktop computer, a wearable device, and the like. In an example embodiment, the system 102 may be hosted on a server. In this scenario, the UE 100 may access the system 102 hosted on the server to enhance the quality of the video. The system 102 may include one or more processors 104, a plurality of modules 106, a memory 108, and an input/output (I/O) interface 109.

In an exemplary embodiment, the one or more processors 104 may be operatively coupled to each of the plurality of modules 106, the memory 108, and the I/O interface 109. In one embodiment, the one or more processors 104 may include at least one data processor for executing processes in Virtual Storage Area Network. The one or more processors 104 may include specialized processing units such as integrated system (bus) controllers, memory management control units, floating point units, graphics processing units, digital signal processing units, etc. In one embodiment, the one or more processors 104 may include a central processing unit (CPU), a graphics processing unit (GPU), or both. The one or more processors 104 may be one or more general processors, digital signal processors, application-specific integrated circuits, field-programmable gate arrays, servers, networks, digital circuits, analog circuits, combinations thereof, or other now-known or later developed devices for analyzing and processing data. The one or more processors 104 may execute a software program, such as code generated manually (i.e., programmed) to perform the desired operation. In an embodiment of the disclosure, the one or more processors 104 may be a general purpose processor, such as the CPU, an application processor (AP), or the like, a graphics-only processing unit such as the GPU, a visual processing unit (VPU), and/or an AI-dedicated processor such as a neural processing unit (NPU). In an embodiment of the disclosure, the one or more processors 104 execute data, and instructions stored in the memory 108 to enhance the quality of the video.

The one or more processors 104 may be disposed in communication with one or more input/output (I/O) devices via the respective I/O interface 109. The I/O interface 109 may employ communication code-division multiple access (CDMA), high-speed packet access (HSPA+), global system for mobile communications (GSM), long-term evolution (LTE), WiMax, or the like, etc.

Using the I/O interface 109, the system 102 may communicate with one or more I/O devices, specifically, the user devices associated with the human-to-human conversation. For example, the input device may be an antenna, microphone, touch screen, touchpad, storage device, transceiver, video device/source, etc. The output devices may be a printer, fax machine, video display (e.g., cathode ray tube (CRT), liquid crystal display (LCD), light-emitting diode (LED), plasma, plasma display panel (PDP), organic light-emitting diode display (OLED) or the like), audio speaker, etc. In an embodiment of the disclosure, the I/O interface 109 may be used to receive one or more enhancement parameters to enhance the quality of the video. Further, the I/O interface 109 may display the video on a user interface screen of the UE 100 upon enhancing the quality of the video based on the received one or more enhancement parameters. The details on the one or more enhancement parameters and enhancing the quality of the video based on the one or more enhancement parameters have been elaborated in subsequent paragraphs.

The one or more processors 104 may be disposed in communication with a communication network via a network interface. In an embodiment, the network interface may be the I/O interface 109. The network interface may connect to the communication network to enable connection of the system 102 with the outside environment. The network interface may employ connection protocols including, without limitation, direct connect, ethernet (e.g., twisted pair 10/100/1000 Base T), transmission control protocol/internet protocol (TCP/IP), token ring, IEEE 802.11a/b/g/n/x, etc. The communication network may include, without limitation, a direct interconnection, local area network (LAN), wide area network (WAN), wireless network (e.g., using wireless application protocol), the internet, and the like.

In some embodiments, the memory 108 may be communicatively coupled to the one or more processors 104. The memory 108 may be configured to store the data, and the instructions executable by the one or more processors 104 for enhancing the quality of the video. In an embodiment of the disclosure, the memory may store the data, such as at least one frame of the video, the one or more enhancement parameters, a plurality of pixels, motion information, a temporal loss, a perceptual loss, a set of blend weights and the like. Details on the data have been elaborated in subsequent paragraphs. Further, the memory 108 may include, but not limited to, a non-transitory computer-readable storage media, such as various types of volatile and non-volatile storage media including, but not limited to, random access memory, read-only memory, programmable read-only memory, electrically programmable read-only memory, electrically erasable read-only memory, flash memory, magnetic tape or disk, optical media and the like. In one example, the memory 108 may include a cache or random-access memory for the one or more processors 104. In alternative examples, the memory 108 is separate from the one or more processors 104, such as a cache memory of a processor, the system 102 memory, or other memory. The memory 108 may be an external storage device or database for storing data. The memory 108 may be operable to store instructions executable by the one or more processors 104. The functions, acts, or tasks illustrated in the figures or described may be performed by the programmed processor/controller for executing the instructions stored in the memory 108. The functions, acts or tasks are independent of the particular type of instruction set, storage media, processor, or processing strategy and may be performed by software, hardware, integrated circuits, firmware, micro-code, and the like, operating alone or in combination. Likewise, processing strategies may include multiprocessing, multitasking, parallel processing, and the like.

In some embodiments, the plurality of modules 106 may be included within the memory 108. The memory 108 may further include a database 110 to store the data for enhancing the quality of the video. The plurality of modules 106 may include a set of instructions that may be executed to cause the system 102 to perform any one or more of the methods/processes disclosed herein. The plurality of modules 106 may be configured to perform the operations of the disclosure using the data stored in the database 110 for enhancing the quality of the video, as discussed herein. In an embodiment, each of the plurality of modules 106 may be a hardware unit which may be outside the memory 108. Further, the memory 108 may include an operating system 112 for performing one or more tasks of the UE 100, as performed by a generic operating system 112 in the communications domain. In one embodiment, the database 110 may be configured to store the information as required by the plurality of modules 106 and the one or more processors 104 for enhancing the quality of the video.

Further, the disclosure also contemplates a computer-readable medium that includes instructions or receives and executes instructions responsive to a propagated signal. Further, the instructions may be transmitted or received over the network via a communication port or interface or using a bus. The communication port or interface may be a part of the one or more processors 104 or may be a separate component. The communication port may be created in software or may be a physical connection in hardware. The communication port may be configured to connect with a network, external media, the display, or any other components in the UE 100, or combinations thereof. The connection with the network may be a physical connection, such as a wired Ethernet connection, or may be established wirelessly. Likewise, the additional connections with other components of the UE 100 may be physical or may be established wirelessly. The network may alternatively be directly connected to the bus. For the sake of brevity, the architecture and standard operations of the operating system 112, the memory 108, the database 110, and the one or more processors 104 are not discussed in detail.

FIG. 2 illustrates a block diagram of the plurality of modules 106 of the system 102 for enhancing the quality of the video, according to an embodiment of the disclosure. The illustrated embodiment of FIG. 2 also depicts a sequence flow of process among the plurality of modules 106 for enhancing the quality of the video. In an embodiment of the disclosure, the plurality of modules 106 may include, but not limited to, a capturing module 202, a segmenting module 204, a receiving module 206, an initiating module 208, an identifying module 210, an applying module 212, a feathering module 214, and a providing module 216. The plurality of modules 106 may be implemented by way of suitable hardware and/or software applications.

The capturing module 202 may be configured to capture a reference image associated with a video. The reference image may be a frame of a plurality of frames of the video, an image associated with the video or a combination thereof via the UE 100. In an embodiment of the disclosure, the image is captured prior to initiating a capturing of the video. The image may be a preview or a thumbnail of the video including one or more subjects of the video to be recorded by the UE 100. In an embodiment of the disclosure, the image is not a part of the plurality of frames. In an embodiment of the disclosure, a field of view (FOV) of the reference image is equivalent to a FOV of the video to be recorded. For example, the one or more subjects may be clouds, waterfall, trees, sky, one or more persons, and the like. In an embodiment of the disclosure, the frame may be a first frame of the plurality of frames. In an example embodiment, the frame may be an intermediate frame of the plurality of frames.

The segmenting module 204 may be configured to segment the reference image into one or more regions. In an embodiment of the disclosure, a FOV of the reference image includes the one or more regions to be included in the video. In segmenting the reference image into the one or more regions, the segmenting module 204 may be configured to segment the reference image into one or more region using one or more region masks. In an embodiment of the disclosure, each of the one or more region masks correspond to pixels of the reference image belonging to the given region. Further, a region mask from the one or more region masks having a value of zero represent the pixels not belonging to a given region. The one or more segmented regions may be further be classified into one or more classes. In an embodiment of the disclosure, the one or more classes correspond to labels of the one or more regions. In an exemplary embodiment of the disclosure, the one or more classes may be landscape, sky, grass, gravel, and the like. In an embodiment of the disclosure, the segmentation module 204 may use panoptic segmentation technique for segmenting the reference image. Panoptic segmentation is a combination of semantic segmentation and instance segmentation. The semantic segmentation provides the one or more region masks for different regions. Further, the instance segmentation provides the one or more classes for each of the one or more region masks.

Furthermore, the receiving module 206 may be configured to receive one or more first enhancement parameters to be applied on a first region of the one or more regions. For example, when the one or more regions correspond to a cloud, a tree, and a waterfall, the first region may correspond to the cloud. In an embodiment of the disclosure, the one or more first enhancement parameters correspond to fine granular controls to be applied on the first region of each of the plurality of frames. For example, the one or more first enhancement parameters may include contrast enhancements, tone enhancements, motion-blur, colour, noise, dynamic range, brightness, highlight, shadows, colour saturation, tint, temperature, sharpness, exposure, tone-maps, and the like. In a scenario, the reference image is displayed on a user interface screen of the UE 100 with the one or more regions and the respective one or more classes. Further, the user may select the first region to change display settings (e.g., brightness) of the first region. Upon selection of the first region, controls for modifying the display settings of the first region are overlaid on the user interface screen of the UE 100. Further, the user may provide the one or more first enhancement parameters by using the controls, such that the one or more enhancement parameters are applied on the first region to modify the display settings. In an embodiment of the disclosure, the user may also preview the effect of modification of the settings on the reference image.

In an example embodiment of the disclosure, the one or more enhancement parameters correspond to image enhancement techniques that use the one or more regions from the plurality of frames. In an exemplary embodiment of the disclosure, the one or more first enhancement parameters include an exposure synthesis for enhancing a dynamic range of the captured video by using the one or more regions from the plurality of frames. The one or more first enhancement parameters may also include one or more motion blur parameters for synthesizing a silhouette of long exposure effect. In an embodiment of the disclosure, the one or more motion blur parameters are associated with long exposure synthesis. The one or more motion blur parameters may be presented to the user by using two approaches i.e., a first approach and a second approach. The first approach corresponds to a combination of exposure value with motion blur as a toggle (ON/OFF) parameter. The second approach corresponds to an explicit motion-blur as a separate parameter. The second approach is dependent on user experience (UX) design. Further, the one or more first enhancement parameters include exposure synthesis for high dynamic range (HDR), noise reduction parameters in one or more relatively static regions of the captured video by using one or more frames from the plurality of frames, or a combination thereof. The one or more first enhancement parameters associated with the exposure synthesis may be represented by a first option and a second option. The first option is exposure Synthesis with motion blur. The first option represents an amount of increase in a motion blur as indicated by a user interface (UI). Further, the second option is exposure synthesis with dynamic range enhancement. The second option represents a desired increase in exposure value as indicated by the UI. In an embodiment of the disclosure, the noise reduction parameters correspond to values by which noise has to be reduced as indicated by the UI. In an embodiment of the disclosure, denoising operation is applied to only specified regions for keeping these specified regions consistent across region boundaries in space and time. The denoising operation is disclosed in equation (1)

$$\hat{x} = u + \frac{{σ}_{c}^{2}}{{σ}_{c}^{2} + {σ}^{2}} ( {x}_{t} - u ) \qquad ( 1 )$$

Where,

$$u = \frac{1}{t} {\sum }_{t} {x}_{t}$$

is the mean of all consistent and aligned pixels {xₜ}, σ_{c}² is the variance of pixels and approximated by max (0, σₜ²−σ²) σₜ and σ are the deviation of {xₜ} and noise respectively. σ is derived from input based on level of denoising to be done.

In an embodiment of the disclosure, the one or more relatively static regions correspond to regions of the plurality of frames with nearly zero or absolute zero motion which is conducive for noise reduction. The details on the one or more motion blur parameters for synthesizing a silhouette of the long exposure effect have been elaborated in subsequent paragraphs at least with reference to FIG. 7.

Conventionally, a motion blur effect in all frames of a video may be achieved by using long exposure. However, this conventional technique may result in overexposure, i.e., saturation of multiple sections of the frames resulting in brightness. In an embodiment of the disclosure, the one or more regions associated with the reference image which require the motion blur effect are identified by using the one or more motion blur parameters. Further, the motion blur effect is applied to the identified one or more regions by using motion information. The application of the motion blur effect on the identified one or more regions may avoid saturation, i.e., pixels saturating towards white, in other regions of the reference image. In an embodiment of the disclosure, the motion information is received in the form of motion vectors. The motion information is represented by using optical flow vectors or motion vectors. Further, the motion information is computed using motion estimation or optic flow. In an embodiment of the disclosure, the motion estimation is a process of determining motion vectors that describe the transformation from one 2D image to another. Further, the optical flow or optic flow is a pattern of apparent motion of objects, surfaces, and edges in a visual scene caused by the relative motion between an observer and a scene.

Thereafter, the initiating module 208 may be configured to initiate, by the UE 100, the capture of the video upon receiving the one or more first enhancement parameters.

In an embodiment of the disclosure, the identifying module 210 may be configured to identify a plurality of pixels associated with the first region in each of the plurality of frames of the captured video. In identifying the plurality of pixels associated with the first region, the identifying module 210 may be configured to track the one or more regions in the plurality of frames based on the one or more region masks and the one or more classes. Further, the identifying module 210 may be configured to warp the tracked one or more regions. The identifying module 210 may be configured to align the warped one or more regions. In an exemplary embodiment of the disclosure, warping the one or more regions corresponds to a process of registering the one or more regions from a previous frame to the same coordinates as a reference region from a current frame. This process is used to locally warp the target region of the image and align with the reference region. Furthermore, the identifying module 210 may be configured to identify a plurality of pixels associated with each of the aligned one or more regions. For example, a region associated with a class “cloud” in an anchor frame (i.e., current frame of the video) may get mapped to only one region of the class “cloud” in any neighboring frame of the video. In an embodiment of the disclosure, the neighboring frame is a frame from the plurality of frames of the video which is located either before the anchor frame or after the anchor frame. Further, the plurality of pixels for the region associated with the class “cloud” is tracked in all neighboring frames of the video.

The details on generating the aligned regions from the video have been elaborated in subsequent paragraphs at least with reference to FIG. 6. The details on generating the aligned regions from the video have been elaborated in subsequent paragraphs at least with reference to FIG. 7.

Furthermore, the applying module 212 may be configured to apply the one or more first enhancement parameters to the identified plurality of pixels associated with the first region in each of the plurality of frames. In applying the one or more first enhancement parameters to the identified plurality of pixels associated with the first region, the applying module 212 may be configured to apply one or more enhancement parameters to the identified plurality of pixels associated with the aligned one or more regions in each of the plurality of frames. In an exemplary embodiment of the disclosure, the one or more enhancement parameters include the one or more first enhancement parameters and one or more second enhancement parameters. In an embodiment of the disclosure, the one or more second enhancement parameters are similar to the one or more first parameters. However, the one or more second parameters are to be applied on a second region from the one or more regions.

Thus, the user may select enhancement parameters to be applied at a finer granular level i.e., individual regions of the image or the video. For example, the user may select 78% brightness for a region associated with a cloud, 54% brightness for a region associated with a waterfall, and 50% brightness for a region associated with mountains. Accordingly, the system 102 adjusts the brightness for each region. In an example, the user may select 20% contrast, 25% exposure, 33% cyan, 38% Magenta, and 48% noise for a region associated with a grass, and 30% contrast, 35% exposure, 43% cyan, 48% Magenta, and 58% noise for a region associated with a grass. Accordingly, the system 102 performs enhancement process for each region.

Further, the receiving module 206 may be configured to receive the one or more second enhancement parameters to be applied on a second region of the one or more regions. The initiating module 208 may be configured to initiate, by the UE 100, the capture of the video upon receiving the one or more second enhancement parameters. Furthermore, the identifying module 210 may be configured to identify a plurality of pixels associated with the second region in each of the plurality of frames of the captured video. The applying module 212 may be configured to apply the one or more second enhancement parameters to the identified plurality of pixels associated with the second region in each of the plurality of frames.

Similarly, the system 102 receives enhancement parameters for each region of the one or more regions and tracks pixels associated with each region in each of the plurality of frames of the captured video. Further, the system 102 applies the received enhancement parameters to the tracked pixels associated with each region in each of the plurality of frames.

In an embodiment of the disclosure, the feathering module 214 may be configured to receive the motion information and the one or more region masks. Further, the feathering module 214 identifies a plurality of overlapping pixels from the one or more regions based on the received motion information and the one or more region masks. In an embodiment of the disclosure, the plurality of overlapping pixels correspond to pixels having same coordinates but belonging to different classes of the one or more regions in different frames of the plurality of frames. The feathering module 214 may also be configured to compute a temporal loss and a perceptual loss of the identified plurality of overlapped regions. Furthermore, the feathering module 214 may be configured to compute a set of blend weights in order to minimize a total loss based on the computed temporal loss and the computed perceptual loss. In an embodiment of the disclosure, the total loss includes the temporal loss and the perceptual loss. The feathering module 214 may be further configured to feather one or more region boundaries associated with the one or more regions by using the computed set of blend weights to smoothen out discontinuities across the one or more regions. In an embodiment of the disclosure, feathering is a process by which the edges of an image are softened or blurred. This feathering process is executed by applying a low-pass filter. In the disclosure, the feathering is applied to smoothen out different enhancement effects across region boundaries since enhancement parameters may widely vary based on user choice across different regions. In an embodiment of the disclosure, the feathering module 214 achieves a temporal consistency in the plurality of images by feathering the one or more region boundaries associated with the one or more regions. In an exemplary embodiment of the disclosure, the temporal loss may be defined as a degradation visible in time-domain. Further, the perceptual loss may be defined as a loss for a given frame in a spatial domain. In an embodiment of the disclosure, the set of blend weights are weights used for weighted averaging of the plurality of pixels from the one or more regions associated with other frames of video over a time interval as referred to in equation (2). The details on performing a temporal consistency operation have been elaborated in subsequent paragraphs at least with reference to FIG. 5.

$${p}_{i} = {\sum }_{t} {w}_{t} {p}_{{t}_{i}} , where \sum {w}_{t} = 1 \qquad ( 2 )$$

Where, t is the time interval decided by the user, wt are blending weights i.e., weight assigned for pixels of region at time t, and pₜ_{ᵢ} is the pixel belonging to same region in the frame at time t, at rasterized location i, and i is the coordinate of the pixel in the current frame. Further, t∈[1, T] where T is the number of frames received as input from user (enhancement parameter) with respect to amount of long exposure (with motion blur) to be applied. Thus, by using the equation (2), weighted averaging is performed in time, picking pixels from regions at every discreet time sample t in interval T.

In an example embodiment of the disclosure, the segmenting module 204 may be configured to segment a first frame or the image from the plurality of frames of the video, while capturing the video, into the one or more regions. In further instances, remaining frames from the plurality of frames are segmented into the one or more regions by using the segmenting module 204.

Further, the providing module 216 may be configured to provide at least a user interface for a user selection of the one or more enhancement parameters to be applied to a selected region of the one or more regions of the first frame. The selected region corresponds to a region from the one or more regions on which the user desires to apply the one or more enhancement parameters.

Furthermore, the applying module 212 may be configured to apply the one or more enhancement parameters to the selected region of the one or more regions of the first frame and a plurality of subsequent frames from the plurality of frames of the video during the video capture. In an embodiment of the disclosure, the plurality of frames are transmitted to a media recorder of the UE 100 for compression upon applying the one or more enhancement parameters.

In an embodiment of the disclosure, the feathering module 214 may be configured to identify, upon applying the one or more enhancement parameters to the selected region of the one or more regions, one or more cluster masks positioned on a boundary of the one or more regions in the plurality of frames based on one or more motion vectors and one or more region masks for each of the plurality of frames. The one or more cluster masks are part of the masks which are overlapped, occluded or falling on the boundary. In an embodiment of the disclosure, the one or more motion vectors are associated with one or more previous frames of a current frame in a time sequence. Further, the feathering module 214 may be configured to identify the plurality of overlapping pixels from the one or more regions based on the identified one or more cluster masks. The feathering module 214 may also be configured to compute the temporal loss and the perceptual loss for the identified plurality of overlapping pixels based on the identified one or more cluster masks. Furthermore, the feathering module 214 may be configured to compute a set of blending weights for the identified plurality of overlapping pixels based on the computed temporal loss and the computed perceptual loss. The feathering module 214 may be configured to feather the identified plurality of overlapping pixels based on the computed set of blending weights. The set of blending weights correspond to a contribution factor of a pixel or a group of pixels, from regions belonging to previous frames and current frame, in computing the final value of the pixel belonging to the given region in current frame. For example, a blending weight may be calculated by using equation (3).

$$\overline{x} = \frac{{\sum }_{i = 1}^{n} {w}_{i} {x}_{i}}{{\sum }_{i = 1}^{n} {w}_{i}} \qquad ( 3 )$$

where, wi are the blending weight for region of ith frame and xi are pixels from the region of ith frame.

The details on operation of the system 102 for enhancing the quality of the video have been elaborated in subsequent paragraphs at least with reference to FIGS. 3A, 3B, 4A, and 4B.

FIGS. 3A and 3B illustrate a block diagram 300 depicting an operation of the system 102 for enhancing the quality of the video, according to an embodiment of the disclosure.

In an embodiment of the disclosure, the user positions the UE 100 towards the one or more subjects to be recorded in the video. As a result of positioning the UE 100, the user is able to preview the one or more subjects on a display screen of the UE 100. Further, a sensor 302 associated with the UE 100 captures the reference image (i.e., the image). The reference image includes the one or more subjects. In an embodiment of the disclosure, the reference image is used as an input by subsequent blocks for allowing the user to adjust fine granular video quality refinements, i.e., the one or more enhancement parameters. Furthermore, the system 102 segments the reference image into the one or more regions.

Further, the user initiates capturing of the video via the sensor upon receiving the one or more enhancement parameters. At operation 304, an image signal processor (ISP) associated with the system 102 converts incoming raw images associated with the video from the sensor to one or more image formats for further processing, as depicted in FIG. 3A. For example, the one or more image formats may be YUV format. In an embodiment of the disclosure, an output of the ISP may be a preview of the video, the image and the video to be recorded.

In an embodiment of the disclosure, at operation 306, a video stabilization engine of the system 102 receives the captured video. Further, the video stabilization engine stabilizes the received video and removes one or more camera shakes caused during shooting of the video. In an embodiment of the disclosure, the one or more camera shakes correspond to an act of accidentally moving the UE 100 while shooting the video resulting in involuntary blurring of a frame associated with the video.

In an example embodiment of the disclosure, the system 102 includes a video decoder 308 in place of the sensor, the ISP, and the video stabilization engine, as depicted in FIG. 3B. The video decoder 308 of the system 102 receives a compressed video and decompresses the received compressed video. In an embodiment of the disclosure, the operation depicted in FIG. 3B is applied on the already recorded video for enhancing the quality of the already recorded video.

Further, at operation 310, a panoptic segmentation process is performed to break down the plurality of frames associated with the video into the one or more regions masks along with the one or more classes. In an embodiment of the disclosure, the panoptic segmentation is performed based on the reference image, and the video.

At operation 312, the system 102 tracks the one or more regions in the plurality of frames based on the one or more region masks and the one or more classes by using the identifying module 210. In an embodiment of the disclosure, an output of the operation 312 is the one or more motion vectors. Further, at operation 314, the system 102 warps the tracked one or more regions and aligns the warped one or more regions to an anchor frame i.e., current frame in the video. In an embodiment of the disclosure, for same class of a region, regions from all frames are warped and aligned to the anchor frame. Further, the anchor frame may include more than one region with associated regions from the neighboring frame that may be considered by the system 102 for the purpose of performing aligning and warping.

Furthermore, at operation 316, the user selects the one or more enhancement parameters for each region of the one or more regions. At operation 318, the system 102 identifies the plurality of pixels associated with each of the aligned one or more regions and applies the one or more enhancement parameters to the identified plurality of pixels associated with the aligned one or more regions in each of the plurality of frames. In an embodiment of the disclosure, at operation 318, the one or more regions are taken as an input because the system 102 considers each of the one or more regions within an anchor frame differently. Accordingly, the user may apply different enhancement parameters on each of the one or more regions. For example, the user may perform a contrast enhancement operation for a first region of the video, a tone enhancement operation for a second region of the video and a motion-blur operation for a third region of the video. Further, at operation 320, a temporal consistency operation is performed to keep the applied one or more enhancement parameters consistent across the one or more region boundaries in space and time. At operation 322, a video encoder compresses the final video upon performing the temporal consistency operation. The details on performing a temporal consistency operation have been elaborated in subsequent paragraphs at least with reference to FIG. 5.

FIG. 4A illustrates a block diagram depicting an operation of the system for enhancing the quality of the video, according to an example embodiment of the disclosure.

In an embodiment of the disclosure, FIG. 4A depicts a camera application 402, a sensor 404, a fine granular video refinement (FGVR) 406, a camera hardware abstraction layer (HAL) 408, and a media recorder 410.

The camera HAL is responsible for configuring the sensor 404 and hardware image signal processor (ISP) to pre-process incoming frames from the sensor 404, send capture commands to the sensor 404 to start receiving incoming frames from the sensor, and perform video stabilization on the received incoming frames after ISP has performed pre-processing. Further, the FGVR 406 includes the panoptic segmentation, region tracking, mask alignment, temporal consistency and region-specific video refinement, as explained with reference to FIG. 1.

The camera application 402 receives the one or more enhancement parameters and outputs the fine granular controls to the user associated with receiving the one or more enhancement parameters. Further, the camera application 402 highlights the one or more regions associated with the thumbnail frame of the video and passes the one or more enhancement parameters to the FGVR block 406.

Further, the media recorder 410 is configured to perform video encoding by the video encoder, as explained with reference to FIGS. 3A and B.

At operation 1, the camera application 402 sends a request to the FGVR 406 for a thumbnail image (i.e., a frame of a plurality of frames of the video) before starting the video recording. Further, at operation 2, the FGVR 406 forwards the request to the camera HAL 408 for capturing the thumbnail image. At operation 3, the camera HAL 408 returns the thumbnail image back to the FGVR 406. At operation 4, the FGVR 406 returns the thumbnail image to the camera application 402 with marked regions and class labels. At operation 5, the camera application 402 sends the fine granular controls to the FGVR 406 for the one or more regions. An embodiment, the one or more regions are selected by the user using the user interface screen. An embodiment, the one or more regions including at least one number of pixels with parameters below a threshold value may be selected by the processor. For example, the one or more first enhancement parameters may include contrast enhancements, tone enhancements, motion-blur, colour, noise, dynamic range, brightness, highlight, shadows, colour saturation, tint, temperature, sharpness, exposure, tone-maps, and the like. At operation 6, the camera application 402 sends a request to the FGVR 406 for starting the video recording. At operation 7, the FGVR 406 forwards the request to the camera HAL 408 for starting the video recording. At operation 8, the camera HAL 408, the thumbnail image, and the one or more frames to the FGVR 406. At operation 9, the FGVR 406 performs the refinement operations as per the received fine granular controls and returns the thumbnail frame to the camera application 402. The refinement operation is performed by applying the fine granular controls on the one or more regions. At operation 10, the FGVR 406 performs the refinement operation as per the received fine granular controls and returns the one or more frames associated with the video the media recorder 410.

FIG. 4B illustrates a block diagram depicting an operation of the system for enhancing the quality of the video, according to an example embodiment of the disclosure.

In an embodiment of the disclosure, a media server may be used in place of the media recorder 410 to perform both video encoding and video decoding of the recorded video.

At operation 1, the camera application 402 sends a request for a thumbnail image (i.e., a first image in a video sequence) to the FGVR 406 before starting video refinement. At operation 2, the FGVR 406 forwards the request to the media decoder 412 for receiving the thumbnail image. At operation 3, the media decoder 412 returns the thumbnail image back to the FGVR 406. At operation 4, the FGVR 406 returns the thumbnail image to the camera application 402 with marked regions and class labels. At operation 5, the camera application 402 sends the fine granular controls to the FGVR 406 for selected regions. At operation 6, the camera application 402 sends the request to the FGVR 406 for receiving decoded frames. At operation 7, the FGVR 406 forwards the request to the media decoder 412 for starting video decoding. At operation 8, the media decoder 412 returns the one or more frames associated with the video to the FGVR 406. At operation 9, the FGVR 406 performs the refinement operations as per the received fine granular controls and returns the one or more frames for preview to the camera application 402 (if user want to view the enhanced video). At operation 10, the FGVR 406 sends the refined video frames to the media recorder 410 for encoding the video.

FIG. 5 illustrates a block diagram depicting the temporal consistency operation, according to an embodiment of the disclosure. In an embodiment of the disclosure, the temporal consistency operation is performed by the system 102.

In an embodiment of the disclosure, when different enhancement parameters are applied on each of the one or more regions, one or more boundaries may be visible with discontinuities in the video. In an embodiment of the disclosure, the one or more boundaries are visible when the one or more regions move across from one frame of the plurality of frames to another frame of the plurality of frames in a video sequence associated with the video. Thus, the system 102 continuously refines a set of blended weights for smooth transition around the one or more regions both in spatial and temporal domains.

At operation 502, the system 102 identifies the one or more cluster masks positioned on a boundary of the one or more regions in the plurality of frames based on the one or more motion vectors and the one or more region masks for each of the plurality of frames. In an embodiment of the disclosure, the one or more motion vectors are associated with the one or more previous frames of a current frame in a time sequence. Further, the system 102 identifies the plurality of overlapping pixels from the one or more regions based on the identified one or more cluster masks.

At operation 504, the system 102 computes the temporal loss and the perceptual loss for the identified plurality of overlapping pixels based on the identified one or more cluster masks, one or more processed regions, and the video. In an embodiment of the disclosure, a total loss is computed as a combination of the temporal loss (Lₜ) and the perceptual loss (Lₚ), as shown in equation (4).

$$L = {L}_{t} + {λ}_{p} {L}_{p} \qquad ( 4 )$$

In an exemplary embodiment of the disclosure, the perceptual loss may be a patch-wise loss function, such as Learned Perceptual Image Patch Similarity (LPIPS), Visual Geometry Group (VGG), Structural Similarity Index (SSIM), and the like. Further, the temporal loss is calculated as a combination of a short term temporal loss and a long term temporal loss by using equation (5). In an embodiment of the disclosure, λ₁, λ₂ are lagrangian multipliers and Tₛ, Tₗ are short term and long-term temporal L1-losses computed using a region from the previous frame and a region from long-term neighboring frame.

$${L}_{t} = {λ}_{1} {T}_{s} + {λ}_{2} {T}_{l} \qquad ( 5 )$$

At operation 506, the system 102 computes the set of blending weights for the identified plurality of overlapping pixels based on the computed temporal loss and the computed perceptual loss. If the computed temporal loss and the computed perceptual loss is higher, a higher weight is given to the pixels belonging to the region from the anchor frame. If the computed temporal loss and the computed perceptual loss is lower, equal weights are given to pixels from all regions.

At operation 508, the system 102 performs feathering, i.e., weight blending, on the identified plurality of overlapping pixels based on the computed set of blending weights. In an embodiment of the disclosure, the set of blending weights are adjusted to avoid picking pixels for blending from the part of a region that is not visible in the anchor frame. This is performed by using the one or more motion vectors and checking a set of coordinates associated with the pixels it is referring to in the reference regions. The adjustment of the set of blending weights is performed to avoid the picking pixels from a region belonging to a different class during processing.

Thus, the system 102 refines the identified plurality of overlapping pixels by blending pixels belonging to regions from previous frames.

FIG. 6 illustrates a block diagram depicting generation of aligned regions from the video at each time stamp, in accordance with an embodiment of the disclosure. In an embodiment of the disclosure, the system 102 generates the aligned regions from the video at each time stamp.

In an embodiment of the disclosure, the one or more regions are selected from the plurality of frames captured in the input video via the UE 100. The one or more regions of the plurality of frames may undergo complex changes in motion during capturing of the plurality of frames i.e., moving from one frame to another frame. In an exemplary embodiment of the disclosure, the complex changes of motion may correspond to a combination of rotation, warping, translation, and scaling. Therefore, the video frames captured during different timestamps (T−2, T−1, T, T+1, T+2) may include one or more image frames 602 in different alignments, i.e., the one or more image frames 602 may include one or more unaligned regions. The timestamp T relates to a current timestamp. At the current timestamp, an anchor frame is captured, where the anchor frame may be considered as a standard frame for aligning all other frames into the alignment of the anchor frame. Further, at the previous timestamps, T−1 and T−2, the one or more frames are also captured with different alignments from the alignment of the anchor frame. Similarly, at the next timestamps, T+1 and T+2, the one or more frames are also captured with different alignments.

Further, one or more segmentation masks 604 may be segmented from the corresponding regions of the plurality of frames. Further, the one or more unaligned regions within the one or more frames 602 and the one or more segmentation masks 604 are provided as input to a region tracking module 606 of the system 102 and a masked region alignment module 608 of the system 102 for receiving one or more aligned regions 610 and one or more aligned segmentation masks 612. In an embodiment of the disclosure, 614 represents a region of interest. The one or more unaligned regions and the one or more unaligned segmentation masks may be required to be aligned to get desired output in a particular alignment.

Further, the region tracking module 606 performs one or more operations, such as a feature detection operation 616, a good features to track operation 618, a feature matching operation 620, and a motion estimation operation 622. The motion estimation operation 622 may also alternatively be recited as a Lucas Kanade (LK) optical view module. In an example embodiment of the disclosure, motion estimation may be used as an alternative to the LK optical view. In the feature detection operation 616, the system 102 receives input from the one or more unaligned regions and the one or more unaligned masks. Upon receiving the input, the system 102 detects one or more features within the one or more unaligned regions. The one or more features may be detected based on a Shi-Thomasi feature detection method. The Shi-Thomasi feature detection method is used for Harris corner detector. The Shi-Thomasi feature detection method is used in context of good feature to track operation 618 which selects strongest corners and discards outliers. Subsequently, in the good feature to track operation 618, the system 102 received the detected one or more features and determines one or more prominent features within the one or more detected features. Further, in the motion estimation operation 622, the system 102 receives the one or more prominent features in each of the one or more regions and estimates a flow or motion of the one or more unaligned regions based on a change of alignment of the received one or more prominent features. Furthermore, the system 102 determines the one or more motion vectors or the one or more flow vectors 623 of the one or more unaligned regions based on the one or more frames 602. In the feature matching operation 620, the system 102 receives the one or more prominent features and determines whether the prominent features are matching in each of the one or more regions.

Furthermore, the masked region alignment module 608 receives matched features based on a result of the feature matching operation 620. The masked region alignment 608 performs one or more operations, such as homography estimation operation 624 and a region warping operation 626. In the homography estimation operation 624, the system 102 maps between the matched features in each unaligned region of the one or more unaligned regions. Further, in the region warping operation 626, the system 102 receives the mapped data and transforms the matched features within the one or more unaligned regions of an image while keeping other regions unchanged. In the region warping operation 626, the system 102 multiple operations which includes selecting the one or more features, specifying the desired transformation or deformation, and applying the transformation to the selected features. The transformation may be of different types, including rotation, scaling, shearing, translation, and affine transformations. Therefore, in the region-warping operation 626, the system 102 generates the one or more aligned regions and one or more aligned masks as the output. In an embodiment of the disclosure, instead of warping the whole frame to get the one or more aligned regions, only pixels belonging to the one or more regions undergo transformation. Thus, the system 102 tracks the one or more regions and aligns the tracked one or more regions with a region in the anchor frame, such that the one or more regions may be used for multi-region based enhancements.

FIG. 7 illustrates a block diagram depicting a region-specific video refinement in a long exposure motion blur scenario, in accordance with an embodiment of the disclosure. In an embodiment of the disclosure, the region-specific video refinement is performed by the system 102.

As depicted, FIG. 7 illustrates one or more aligned regions 702 with a change of local motion. The one or more aligned regions 702 include an anchor frame 704 captured in the timestamp T of the captured video. Further, a corresponding region mask 706 is segmented from the anchor frame 704. Further, the system 102 receives the one or more aligned regions 702, the anchor frame 704, the region mask 706, and the one or more enhancement parameters to perform a set of operations, such as a blend weight computation operation 708, a blending with motion blur operation 710, and a boundary smoothening operation 712. The one or more operations are configured for processing video-specific refinement in long exposure, i.e., to process the video frame with motion blur. In the blend weight computation operation 708, the system 102 determines the set of blending weights in the received one or more aligned regions 702. The blending is calculated by using a blending function, as mentioned in the equation (2).

Subsequently, in the blending with motion blur operation 710, the system 102 receives the calculated set of blending weights associated with each of the one or more aligned regions 702 for blending multiple aligned regions of images into a target image with a seamless transition between the images based on the blending function value. In case of blending with motion blur, equation (2) is applied.

Further, in boundary smoothening operation 712, the system 102 receives the blended target image for boundary smoothening. Upon performing the boundary smoothening operation, the system 102 generates a set of processed video frames 714 with motion blur.

FIG. 8 is a flow diagram illustrating a method 800 for enhancing the quality of a video, according to an embodiment as disclosed herein. In an embodiment of the disclosure, the method 800 is performed by the system 102.

At operation 802, the method 800 includes capturing the reference image associated with the video via the user equipment (UE) 100. In an embodiment of the disclosure, the reference image may be the frame of the plurality of frames of the video, the image associated with the video, or a combination thereof. In an embodiment of the disclosure, the image is captured prior to initiating the capturing of the video.

At operation 804, the method 800 includes segmenting the captured reference image into the one or more regions. In one embodiment, the FOV of the reference image comprises the one or more regions to be included in the video. In one embodiment, the method 800 includes segmenting the reference image into the more region using the one or more region masks. The one or more segmented regions may be further be classified into the one or more classes.

At operation 806, the method 800 includes receiving the one or more first enhancement parameters to be applied on the first region of the one or more regions. In one embodiment, the one or more first enhancement parameters comprise at least one of the exposure synthesis for enhancing the dynamic range of the captured video by using the one or more regions from the plurality of frames, the one or more motion blur parameters for synthesizing the silhouette of long exposure effect, or the noise reduction parameters in one or more relatively static regions of the captured video by using the one or more frames from the plurality of frames. In one embodiment, the method 800 includes receiving the one or more second enhancement parameters to be applied on the second region of the one or more regions.

At operation 808, the method 800 includes initiating the capture of the video upon receiving the one or more first enhancement parameters. In one embodiment, the method 800 includes initiating the capture of the video upon receiving the one or more second enhancement parameters.

At operation 810, the method 800 includes identifying the plurality of pixels associated with the first region in each of the plurality of frames of the captured video. In one embodiment, the method 800 includes identifying the plurality of pixels associated with the second region in each of the plurality of frames of the captured video. In one embodiment, the method 800 includes tracking the one or more regions in the plurality of frames based on the one or more region masks and the one or more classes. In one embodiment, the method 800 includes warping the tracked one or more regions. In one embodiment, the method 800 includes aligning the warped one or more regions. In one embodiment, the method 800 includes identifying the plurality of pixels associated with each of the aligned one or more regions.

At operation 812, the method 800 includes applying the one or more first enhancement parameters to the identified plurality of pixels associated with the first region in each of the plurality of frames. In one embodiment, the method 800 includes applying the one or more second enhancement parameters to the identified plurality of pixels associated with the second region in each of the plurality of frames. In one embodiment, the method 800 includes applying one or more enhancement parameters to the identified plurality of pixels associated with the aligned one or more regions in each of the plurality of frames, wherein the one or more enhancement parameters comprise the one or more first enhancement parameters and the one or more second enhancement parameters.

FIG. 9 is a flow diagram illustrating a method 900 for feathering one or more region boundaries, in accordance with an embodiment of the disclosure. In an embodiment of the disclosure, the method 900 is performed by the system 102 by using the one or more processors 104, as depicted in FIG. 1.

At operation 902, the method 900 includes receiving the motion information and the one or more region masks.

At operation 904, the method 900 includes identifying the plurality of overlapping pixels from the one or more regions based on the received motion information and the one or more region masks.

At operation 906, the method 900 includes computing the temporal loss and the perceptual loss of the identified plurality of overlapped regions.

At operation 908, the method 900 includes computing the set of blend weights in-order to minimize the total loss based on the computed temporal loss and the computed perceptual loss. In an embodiment of the disclosure, the total loss includes the temporal loss and the perceptual loss.

At operation 910, the method 900 includes feathering the one or more region boundaries associated with the one or more regions by using the computed set of blend weights to smoothen out discontinuities across the one or more regions.

FIG. 10 is a flow diagram illustrating a method for enhancing the quality of the video, in accordance with an example embodiment of the disclosure. In an embodiment of the disclosure, the method 1000 is performed by the system 102 by using the one or more processors 104, as depicted in FIG. 1.

At operation 1002, the method 1000 includes segmenting the first frame from the plurality of frames of the video, while capturing the video, into the one or more regions, which relates to operation 804 of FIG. 8.

At operation 1002, the method 400 includes providing at least the user interface for the user selection of the one or more enhancement parameters to be applied to the selected region of the one or more regions of the first frame, which relates to operation 806 of FIG. 8.

At operation 1006, the method 1000 includes applying the one or more enhancement parameters to the selected region of the one or more regions of the first frame and the plurality of subsequent frames of the video during the video capture, which relates to operation 812 of FIG. 8.

FIG. 12A and 12B illustrate a user interface screen for selecting a region and applying an enhancement parameter to the selected region according to an embodiment.

Referring FIG. 12A, at 1201, before starting the recording, a preview or a thumbnail of the video is captured by the capture module 202.

At 1202, the regions labels and associated masks are detected by the segmentation module 204. A plurality of labels, for example, sky, landscape, grass, gravel, etc., are presented to the user interface screen to select by the user.

At 1203, a particular label of the plurality of labels is selected and the region masks gets highlighted along with controls to change the region specific settings.

At 1204, the settings of the enhancement parameter for the selected region are modified and saved by the user input using the user interface. Referring FIG. 12B, on the selection of region, user input controls (a contrast, a exposure, a color, a noise, etc.) for changing settings of the enhancement parameters are overlaid on the screen and the enhancement parameters are modified by these controls. It may be deployed to improve contrast and dynamic range of the sky region without impacting other regions by using the user interface screen.

At 1205, settings for other regions are changed by repeating 1203 and 1204.

At 1206, Video recording is started by user input using the user interface.

FIG. 11 is a flow diagram illustrating a method for feathering one or more region boundaries, in accordance with an example embodiment of the disclosure. In an embodiment of the disclosure, the method 1100 is performed by the system 102 by using the one or more processors 104, as depicted in FIG. 1.

At operation 1102, the method 1100 includes identifying, upon applying the one or more enhancement parameters to the selected region of the one or more regions, the one or more cluster masks positioned on the boundary of the one or more regions in the plurality of frames based on the one or more motion vectors and the one or more region masks for each of the plurality of frames. The one or more motion vectors are associated with the one or more previous frames of a current frame in the time sequence.

At operation 1104, the method 1100 includes identifying the plurality of overlapping pixels from the one or more regions based on the identified one or more cluster masks, which relates to operation 904 of FIG. 9.

At operation 1106, the method 1100 includes computing the temporal loss and the perceptual loss for the identified plurality of overlapping pixels based on the identified one or more cluster masks, which relates to operation 906 of FIG. 9.

At operation 1108, the method 1100 includes computing the set of blending weights for the identified plurality of overlapping pixels based on the computed temporal loss and the computed perceptual loss.

At operation 1110, the method 1100 includes feathering the identified plurality of overlapping pixels based on the computed set of blending weights, which relates to operation 910 of FIG. 9.

While the above operations shown in FIGS. 8 to 11 are described in a particular sequence, the operations may occur in variations to the sequence in accordance with various embodiments of the disclosure. Further, the details related to various operations of FIGS. 8 to 11, which are already covered in the description related to FIGS. 1 to 7 are not discussed again in detail here for the sake of brevity.

The disclosed method has several technical advantages over the conventional methods. In conventional methods, for example, the electronic device applies a common setting globally on every pixel or region, to all video frames. However, each pixel or region of the image frame has a unique perceptual relevance and aesthetic enhancement requirement. The disclosed approach applies more sophisticated aesthetic effects to video (e.g., long exposure silhouette employing motion blurs) while maintaining static regions crystal sharp, and it also enables optimized multi-frame processing for HDR. As a result, processing is limited to only those areas that require such upgrades, which improves the processing ability.

The disclosure provides for various technical advancements based on the key features discussed above. Further, the disclosure allows for selection of enhancement parameters that may be controlled at a finer granular level. The disclosure enables the user interface of the UE 100 to display the one or more regions of each of the plurality of frames, such that the user may select the enhancement parameters associated with each of the one or more regions for controlling video quality. Thus, the user may select and apply different enhancement parameters to each of the one or more regions of the video or image. The disclosure improves video quality under all lighting conditions through fine granular video controls by segmenting each of the plurality of frames into the one or more regions. The disclosure achieves the temporal consistency in the plurality of images by feathering the one or more region boundaries associated with the one or more regions. In video, every pixel/region has a different perceptual relevance and need for aesthetic enhancements. Instead of applying common settings globally, to all frames, the disclosure enables user guided region-specific settings. For example, an input may provide for different enhancement parameters for each region of the plurality of frames associated with the video. Thus, the system may generate sophisticated artistic effects (e.g., long exposure silhouette using motion blurs) to the video while keeping static regions crystal sharp. The disclosure may also enable optimized multi-frame processing for the HDR by reducing the processing to regions associated with the video which require enhancements. The system may also achieve HDR effects for selected portions of the one or more regions that are either under exposed or over exposed. Thus, the disclosure provides a controllable video HDR technique.

Further, the disclosure may generate silhouette effects (e.g., silky water falls with sharp static backgrounds). By using the disclosure, the system may create a video that has significantly different tone curve for different regions. The system may also create a video output that has motion blur in certain regions and sharp details in other regions. The disclosure may also create an 8-bit video having a large dynamic range, perceptually. For example, a foreground object is enhanced in the presence of a strong backlight. Furthermore, the disclosure may be deployed to improve the contrast and the dynamic range of a sky region without impacting other regions of the image or the video. The disclosure may be deployed to control and give dramatic colour enhancement effects for landscape regions without affecting other parts of the image or video. Further, the disclosure may be deployed to create a silky smooth waterfall effect without blurring or oversaturating other parts of the image or the video. Also, the disclosure may be deployed to create a starry sky with noise greatly reduced using interpolated pixels from multiple frames without losing out details in the other regions of the image or the video.

The plurality of modules 106 may be implemented by any suitable hardware and/or set of instructions. Further, the sequential flow associated with the plurality of modules 106 illustrated in FIG. 2 is exemplary in nature and the embodiments may include the addition/omission of operations as per the requirement. In some embodiments, the one or more operations performed by the plurality of modules 106 may be performed by the one or more processor 104 based on the requirement.

In an embodiment of the disclosure, reasoning prediction is a technique of logically reasoning and predicting by determining information and includes, e.g., knowledge-based reasoning, optimization prediction, preference-based planning, or recommendation.

While the disclosure has been illustrated and described with reference to various example embodiments, it will be understood that the various example embodiments are intended to be illustrative, not limiting. It will be further understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

What is claimed is:

1. A method for capturing a video with enhanced quality, the method comprising:
capturing a reference image via a user equipment (UE), wherein the reference image is at least one frame of a plurality of frames of the video or an image associated with the video;
segmenting the captured reference image into one or more regions;
receiving one or more first enhancement parameters for a first region of the one or more regions;
initiating a capture of the video based on the one or more first enhancement parameters;
identifying a plurality of pixels associated with the first region in each of the plurality of frames of the captured video; and
applying the one or more first enhancement parameters to the identified plurality of pixels associated with the first region in each of the plurality of frames.

2. The method as claimed in claim 1, further comprising:
receiving one or more second enhancement parameters for a second region of the one or more regions;
initiating the capture of the video based on the one or more second enhancement parameters;
identifying a plurality of pixels associated with the second region in each of the plurality of frames of the captured video; and
applying the one or more second enhancement parameters to the identified plurality of pixels associated with the second region in each of the plurality of frames.

3. The method as claimed in claim 1, wherein a field of view (FOV) of the reference image includes the one or more regions included in the video.

4. The method as claimed in claim 1, wherein the one or more first enhancement parameters include at least one of:
an exposure synthesis for enhancing a dynamic range of the captured video based on the one or more regions from the plurality of frames,
one or more motion blur parameters for synthesizing a silhouette of long exposure effect, or
noise reduction parameters in one or more relatively static regions of the captured video based on one or more frames from the plurality of frames.

5. The method as claimed in claim 1, wherein the segmenting the reference image into the one or more regions comprises:
segmenting the reference image into one or more regions according to one or more region masks.

6. The method as claimed in claim 5, wherein the identifying the plurality of pixels associated with the first region, comprises:
tracking the one or more regions in the plurality of frames based on the one or more region masks and one or more classes;
warping the tracked one or more regions;
aligning the warped one or more regions; and
identifying a plurality of pixels associated with each of the aligned one or more regions.

7. The method as claimed in claim 6, wherein the applying the one or more first enhancement parameters to the identified plurality of pixels associated to the first region, comprises:
applying one or more enhancement parameters to the identified plurality of pixels associated with the aligned one or more regions in each of the plurality of frames, wherein the one or more enhancement parameters include the one or more first enhancement parameters and one or more second enhancement parameters.

8. The method as claimed in claim 1, further comprising:
receiving motion information and one or more region masks;
identifying a plurality of overlapping pixels from the one or more regions based on the received motion information and the one or more region masks;
determining a temporal loss and a perceptual loss of the identified plurality of overlapped regions;
determining a set of blend weights to minimize a total loss based on the determined temporal loss and the determined perceptual loss, wherein the total loss includes the temporal loss and the perceptual loss; and
feathering one or more region boundaries associated with the one or more regions by using the determined set of blend weights on discontinuities across the one or more regions.

9. A method for capturing a video with enhanced quality, the method comprising:
segmenting a first frame of a plurality of frames of the video into one or more regions, while capturing the video;
providing at least one user interface for a user selection of one or more enhancement parameters for a selected region of the one or more regions of the first frame; and
applying the one or more enhancement parameters to the selected region of the one or more regions of the first frame and a plurality of subsequent frames of the video during the video capture.

10. The method as claimed in claim 9, further comprising:
identifying, upon applying the one or more enhancement parameters to the selected region of the one or more regions, one or more cluster masks positioned on a boundary of the one or more regions in the plurality of frames based on one or more motion vectors and one or more region masks for each of the plurality of frames, wherein the one or more motion vectors are associated with one or more previous frames of a current frame in a time sequence;
identifying a plurality of overlapping pixels from the one or more regions based on the identified one or more cluster masks;
determining a temporal loss and a perceptual loss for the identified plurality of overlapping pixels based on the identified one or more cluster masks;
determining a set of blending weights for the identified plurality of overlapping pixels based on the determined temporal loss and the determined perceptual loss; and
feathering the identified plurality of overlapping pixels based on the determined set of blending weights.

11. A system for capturing a video with enhanced quality, the system comprising:
memory storing instructions; and
one or more processors,
wherein the instructions, when executed by the one or more processors individually or collectively, cause the system to:
capture a reference image via a user equipment (UE), wherein the reference image is at least one frame of a plurality of frames of the video or an image associated with the video,
segment the captured reference image into one or more regions,
receive one or more first enhancement parameters for a first region of the one or more regions,
initiate a capture of the video based on the one or more first enhancement parameters,
identify a plurality of pixels associated with the first region in each of the plurality of frames of the captured video, and
apply the one or more first enhancement parameters to the identified plurality of pixels associated with the first region in each of the plurality of frames.

12. The system as claimed in claim 11, wherein the instructions, when executed by the one or more processors individually or collectively, cause the system to:
receive one or more second enhancement parameters for a second region of the one or more regions;
initiate the capture of the video based on the one or more second enhancement parameters;
identify a plurality of pixels associated with the second region in each of the plurality of frames of the captured video; and
apply the one or more second enhancement parameters to the identified plurality of pixels associated with the second region in each of the plurality of frames.

13. The system as claimed in claim 11, wherein a field of view (FOV) of the reference image includes the one or more regions included in the video.

14. The system as claimed in claim 11, wherein the one or more first enhancement parameters include at least one of:
an exposure synthesis for enhancing a dynamic range of the captured video based on the one or more regions from the plurality of frames,
one or more motion blur parameters for synthesizing a silhouette of long exposure effect, or
noise reduction parameters in one or more relatively static regions of the captured video based on one or more frames from the plurality of frames.

15. The system as claimed in claim 11, wherein, for segmenting the reference image into the one or more regions, the instructions, when executed by the one or more processors individually or collectively, cause the system to:
segment the reference image into one or more regions according to one or more region masks.

16. The system as claimed in claim 15, wherein, for identifying the plurality of pixels associated with the first region, the instructions, when executed by the one or more processors individually or collectively, cause the system to:
track the one or more regions in the plurality of frames based on the one or more region masks and one or more classes;
warp the tracked one or more regions;
align the warped one or more regions; and
identify a plurality of pixels associated with each of the aligned one or more regions.

17. The system as claimed in claim 16, wherein, for applying the one or more first enhancement parameters to the identified plurality of pixels associated to the first region, the instructions, when executed by the one or more processors individually or collectively, cause the system to:
apply one or more enhancement parameters to the identified plurality of pixels associated with the aligned one or more regions in each of the plurality of frames, wherein the one or more enhancement parameters include the one or more first enhancement parameters and one or more second enhancement parameters.

18. The system as claimed in claim 11, wherein the instructions, when executed by the one or more processors individually or collectively, cause the system to:
receive motion information and one or more region masks,
identify a plurality of overlapping pixels from the one or more regions based on the received motion information and the one or more region masks,
determine a temporal loss and a perceptual loss of the identified plurality of overlapped regions,
determine a set of blend weights to minimize a total loss based on the determined temporal loss and the determined perceptual loss, wherein the total loss comprises the temporal loss and the perceptual loss, and
feather one or more region boundaries associated with the one or more regions by using the determined set of blend weights on discontinuities across the one or more regions.
